(19) United States
(12) Patent Application Publication
(10) Pub. No.: US 2026/0337889 A1
(43) Pub. Date: Oct. 29, 2026

(54) CORONA-RESISTANT MICA/ARAMID FIBER COMPOSITE MATERIAL FOR NEW ENERGY VEHICLE AND PREPARATION METHOD THEREOF

(71) Applicant: ATOMDRIVE TECHNOLOGY (JIANGSU) CO., LTD., Suzhou (CN)

(72) Inventors: Guanghui ZHENG, Suzhou (CN); Wen WANG, Suzhou (CN); Ling ZHANG, Suzhou (CN); Peizhen ZHAO, Suzhou (CN); Jinyu ZHENG, Suzhou (CN); Song LU, Suzhou (CN)

(21) Appl. No.: 19/122,286

(22) PCT Filed: Oct. 8, 2023
(86) PCT No.: PCT/CN2023/123390

§ 371 Date: Apr. 18, 2025

(30) Foreign Application Priority Data
Oct. 20, 2022 (CN) 202211286443.2
Oct. 20, 2022 (CN) 202211286451.7

(51) Int. Cl. D21H 27/32; B32B 29/00; D21H 13/26; D21H 13/44; D21H 27/38

(52) U.S. Cl. CPC D21H 27/32; B32B 29/005; D21H 13/26; D21H 13/44; D21H 27/38; B32B 2250/26; B32B 2255/12; B32B 2255/20

(57) ABSTRACT

The present invention provides a corona-resistant mica/aramid fiber composite material for a new energy vehicle and a preparation method thereof. Preparation raw materials comprise a modified aramid fiber material, an adhesive and a modified mica material; the modified mica material comprises mica powder, a hydrochloric acid solution, ethanol, a silane coupling agent, methyl methacrylate, an initiator and methylbenzene; the mica powder is composed of first mica powder, second mica powder and third mica powder, the particle size of the first mica powder is 90-110 μm, the particle size of the second mica powder is 130-150 μm, and the particle size of the third mica powder is 200-230 μm; and the weight ratio of the first mica powder to the second mica powder to the third mica powder is 1:(3-5):(3-5).

The present application claims priority benefits to Chinese Patent Application No. 202211286443.2, filed with the China National Intellectual Property Administration on Oct. 20, 2022, entitled “CORONA-RESISTANT MICA/ARAMID FIBER COMPOSITE MATERIAL FOR NEW ENERGY VEHICLE AND PREPARATION METHOD THEREOF”, and to Chinese Patent Application No. 202211286451.7, filed with the China National Intellectual Property Administration on Oct. 20, 2022, entitled “CORONA-RESISTANT MICA/ARAMID FIBER BLENDED PAPER FOR NEW ENERGY VEHICLE AND PREPARATION METHOD THEREOF”. The entire contents of the above two prior applications are incorporated herein by reference.

### TECHNICAL FIELD

The present application relates to the field of insulating materials, especially to the field of mica composite materials, and more specifically to a corona-resistant mica/aramid fiber composite material for a new energy vehicle and a preparation method thereof.

### BACKGROUND

Currently, most of the slot insulation paper and interphase insulation paper for motors in new energy vehicles with high-temperature resistance above class H are primarily made of pure aramid fiber paper or composites made of aramid fiber paper and polyimide film bonded together with high-temperature-resistant adhesives. A typical structure of the composite paper is Nomex fiber paper/PI film/Nomex fiber paper (NHN). Epoxy, polyurethane or polyacrylate adhesives are commonly adopted as the composite adhesives.

Pure aramid fiber paper or NHN composite paper has high heat resistance, and its performance is excellent when used in the insulation structure of motors in the 400 V voltage platform of the new energy vehicles. However, for motors in the 800 V voltage platform, due to the higher voltage level, combined with the pulse-width modulation peak voltage and the influence of environmental factors, the maximum safe voltage may reach 2300 V or even higher, which far exceeds the partial discharge inception voltage (PDIV) of existing conventional insulating materials for low-voltage motors. The probability of partial discharge occurring during the operation of motors is very high. Therefore, for automotive motors in the 800 V voltage platform, the corona resistance of the insulating materials must be considered.

In the prior art, the corona-resistant life of composite paper is improved by adding mica components to organic aramid fiber paper or by compositing aramid fiber paper and mica paper using epoxy, polyurethane or polyacrylate adhesives. However, the mica-containing composite papers prepared by these two methods generally have problems such as being prone to powder shedding, cracking and delamination. Their corona resistance and high-temperature resistance are at an average level, failing to meet the process requirements for the large-scale application of motors in the new energy vehicles.

### SUMMARY

To solve the above problems, a corona-resistant mica/aramid fiber composite material for a new energy vehicle and a preparation method thereof are provided. In the present application, a modified mica material and a modified aramid fiber material with excellent corona resistance are provided. Moreover, high-temperature-resistant adhesives with low dielectric constants, such as a PFA-tetrafluoroethylene-perfluoroalkoxy vinyl ether copolymer, an FEP-fluorinated ethylene propylene copolymer (F46, a copolymer of tetrafluoroethylene and hexafluoropropylene), an ETFE-ethylene-tetrafluoroethylene copolymer, PEEK-polyetheretherketone and PEI-polyetherimide, are used. By hot-pressing and compositing or mixing the modified aramid fiber material and the modified mica material followed by hot-pressing, the overall compactness, interleaving processability, corona resistance, partial discharge inception voltage (PDIV) and temperature resistance class of the composite material can be improved. Using this material as slot bottom insulation paper and inter-phase insulation paper can significantly improve the electrical insulation performance and long-term safe operation life of motors in new energy vehicles.

According to one aspect of the present application, a corona-resistant mica/aramid fiber composite material for a new energy vehicle is provided, where raw materials for preparing the composite material include: a modified aramid fiber material, an adhesive and a modified mica material, wherein
the adhesive includes one or more of a tetrafluoroethylene-perfluoroalkoxy vinyl ether copolymer, a fluorinated ethylene propylene copolymer, an ethylene-tetrafluoroethylene copolymer, polyetheretherketone and polyetherimide, and
the modified mica material is prepared from raw materials of: mica powder, a hydrochloric acid solution, ethanol, a silane coupling agent, methyl methacrylate, an initiator and methylbenzene, wherein
the mica powder consists of first mica powder, second mica powder and third mica powder, a particle size of the first mica powder is 90-110 μm, a particle size of the second mica powder is 130-150 μm, and a particle size of the third mica powder is 200-230 μm; and a weight ratio of the first mica powder, the second mica powder and the third mica powder is 1:(3-5):(3-5) in sequence.

Further, the adhesive is an FEP-fluorinated ethylene propylene copolymer (F46, a copolymer of tetrafluoroethylene and hexafluoropropylene). Further, the adhesive includes an FEP-fluorinated ethylene propylene copolymer (F46, a copolymer of tetrafluoroethylene and hexafluoropropylene) and polyetheretherketone in a weight ratio of 3:1.

Specifically, a concentration of the hydrochloric acid solution is 2 mol/L.

Optionally, a weight ratio of the silane coupling agent to the mica powder is (0.05-0.08):1, a weight ratio of the mica powder to methyl methacrylate and the initiator is 1:(0.1-0.15):(0.002-0.005) in sequence, and a weight ratio of the mica powder to ethanol and methylbenzene is 1:(6-8):(5-8) in sequence.

Optionally, a method for preparing the modified mica material includes steps of:
S11, adding the silane coupling agent into ethanol, and adjusting a pH value to 4 by using the hydrochloric acid solution; S12, adding the mica powder, heating to 60-80 °C, stirring for 1-3 h, and filtering, washing and drying; and
S13, adding the mixture into methylbenzene, adding methyl methacrylate and the initiator simultaneously for reaction at 70-90 °C for 2-4 h, and after filtering, drying at 110-130 °C for 0.5-2 h.

Specifically, a mass concentration of a pulp is 3-5%.

Optionally, the silane coupling agent is A171, and the initiator is benzoyl peroxide.

Optionally, the modified aramid fiber material is prepared from a meta-aramid chopped fiber and a meta-aramid fibrid, lengths of the meta-aramid chopped fiber and the meta-aramid fibrid are both 2-3 mm, and a weight ratio of the meta-aramid chopped fiber to the meta-aramid fibrid is 1:(2-2.5).

Optionally, a method for preparing the modified aramid fiber material includes steps of:
S21, disintegrating and dispersing the meta-aramid chopped fiber and the meta-aramid fibrid to form a slurry, and
S22, performing ultrasonic treatment on the slurry. Specifically, a mass concentration of the slurry is 0.1-0.5%.

Optionally, the ultrasonic treatment step is to perform ultrasonic treatment for a total of 6-9 min with 10 s each time and an interval of 3 s; and ultrasonic parameters are a frequency of 10-20 kHz and a power of 500 W.

Optionally, the modified aramid fiber material is modified aramid paper, and the modified mica material is modified mica paper, and
weight percentages of the raw materials are as follows: 40-60% of the modified aramid fiber paper, 5-20% of the adhesive and 40-60% of the modified mica paper.

Optionally, the method for preparing the modified mica material further includes: S14, adding water and stirring evenly to form a pulp, and performing sheet formation through a paper sheet former to obtain the modified mica paper.

Optionally, the method for preparing the modified aramid fiber material further includes: S23, performing sheet formation through a paper sheet former to obtain the modified aramid fiber paper.

Optionally, during the process of “S21, disintegrating and dispersing the meta-aramid chopped fiber and the meta-aramid fibrid to form a slurry”, water is added.

Optionally, the modified aramid fiber material is a modified aramid fiber, the modified mica material is modified mica powder, and
a weight ratio of the modified aramid fiber to the modified mica powder is (0.1-0.5):1, and an amount of the adhesive added is 5-10% of a total weight of the modified aramid fiber and the modified mica powder.

According to another aspect of the present application, a method for preparing the above corona-resistant mica/aramid fiber composite material for a new energy vehicle is provided, including steps of:
S01, unwinding two rolls of the modified aramid fiber paper, and coating the adhesive on surfaces thereof separately;
S02, unwinding the modified mica paper, first attaching the modified mica paper to one modified aramid fiber paper coated with the adhesive, then attaching the other modified aramid fiber paper coated with the adhesive to the other side of the modified mica paper, and oven-drying; and
S03, performing a hot-pressing on a dried composite material through a hot roller to finally obtain the corona-resistant mica/aramid fiber composite material for the new energy vehicle.

According to yet another aspect of the present application, a method for preparing the above corona-resistant mica/aramid fiber composite material for a new energy vehicle is provided, including steps of:
S01, mixing the modified mica powder with water to make a pulp with a mass concentration of 2-10%, and mixing the modified aramid fiber with water to make a pulp with a mass concentration of 0.1-1%;
S02, mixing and stirring the modified mica powder pulp, the modified aramid fiber pulp and the adhesive evenly; and
S03, adding a mixed pulp into a paper sheet former for sheet formation, after pressing, oven-drying, and then performing a hot-pressing through a hot roller to finally obtain a corona-resistant mica/aramid fiber blended paper for the new energy vehicle.

Optionally, an oven-drying temperature is 120 °C, a hot-pressing temperature is 265-310 °C, and a hot-pressing pressure is 20 MPa.

The beneficial effects of the present application include but are not limited to:

1. According to the corona-resistant mica/aramid fiber composite material for the new energy vehicle according to the present application, by using high-temperature-resistant adhesives with low dielectric constants such as a PFA-tetrafluoroethylene-perfluoroalkoxy vinyl ether copolymer, an FEP-fluorinated ethylene propylene copolymer (F46, a copolymer of tetrafluoroethylene and hexafluoropropylene), an ETFE-ethylene-tetrafluoroethylene copolymer, PEEK-polyetheretherketone and PEI-polyetherimide to composite the modified aramid fiber material and the modified mica material, and in combination with the modified mica material and the modified aramid fiber material with excellent corona resistance, the overall compactness, interleaving processability, corona resistance, partial discharge inception voltage (PDIV) and temperature resistance class of the composite material can be improved.

2. According to the corona-resistant mica/aramid fiber composite material for the new energy vehicle according to the present application, by defining that the mica powder is composed of three types of mica powders with different particle sizes and simultaneously defining their respective proportions, the mica powder with a large particle size has a complete lamellar structure, which can play a relatively good role in stress transfer, avoid the fracture of the paper due to concentrated stress, and at the same time endow the paper with certain stiffness. The mica powder with a small particle size, which accounts for a relatively small proportion, fills the gaps between the large mica flakes, which can endow the paper with relatively good strength performance, reduce the destructive effect on the fibers, and form a “brick-and-mortar” structure, which can endow the paper with relatively good strength performance;

where, the lamellar structures of the two types of mica powders with relatively large particle sizes can act as “bricks”, providing more attachment carriers for the fibrids. Moreover, the regular arrangement of the two types of mica powders with relatively large particle sizes also endows the paper with relatively good flatness. They have relatively large aspect ratios, and the high insulation effect in the Z-direction of lamellas can effectively block the current, delay the formation of the current channel, effectively delay the spread of the arc, reduce the carbonization damage of the fibers, decrease the size and area of the breakdown point, and improve the corona resistance.

3. According to the corona-resistant mica/aramid fiber composite material for the new energy vehicle according to the present application, the mica material is modified by a composite of a silane coupling agent and polymer monomers. There are hydroxyl groups on the surface of the mica powder. The silane coupling agent A171 is used to introduce double bonds on the surface of the powder. Then, the monomers and initiator are added to the mica powder liquid for a polymerization reaction. The vinyl groups on the surface of the mica powder copolymerize with the monomers to achieve surface grafting of the polymer, which improves its dispersibility in the slurry and ultimately enhances its interfacial bonding performance with the modified aramid fiber material.

4. According to the corona-resistant mica/aramid fiber composite material for the new energy vehicle in the present application, by defining the ratio of the silane coupling agent to the mica powder, the grafting rate on the surface of the mica powder is increased; by defining the ratio of the mica powder to the monomers and initiator, the coating rate of the polymer is increased.

5. According to the corona-resistant mica/aramid fiber composite material for the new energy vehicle in the present application, the meta-aramid chopped fibers and meta-aramid fibrids are used, and their lengths and proportions are defined. The chopped fibers have a rod-like structure, while the fibrids are in the form of thin films. Within this proportion range, the fibrids will adhere to the rod-like chopped fibers, which helps the chopped fibers form a support and become the backbone for the fibrids to attach to. When subjected to external forces, it can play a role in stress transfer. At the same time, the network structure formed by the interweaving of the chopped fibers makes the composite material highly dense, with excellent corona resistance and long service life.

6. According to the corona-resistant mica/aramid fiber composite material for the new energy vehicle according to the present application, by ultrasonically modifying and mixing the aramid fibers, the degree of surface fibrillation of the aramid fibers can be enhanced, the number of surface active groups and the surface energy can be increased, thereby improving the dispersion performance of the meta-aramid chopped fibers. At the same time, the specific surface area and surface roughness of the aramid fibers can be increased, which can increase the interweaving force between the chopped fibers and the fibrids, cause the aramid fibers to exhibit a fibrillation phenomenon, and enhance the mechanical interlocking effect between the fiber interfaces, thus improving the mechanical properties and high-temperature resistance of the composite material.

7. According to the first method for preparing the corona-resistant mica/aramid fiber composite material for the new energy vehicle according to the present application, through high-temperature hot-pressing molding and by defining the hot-pressing temperature, the chopped fibers and the fibrids are fully softened and bonded. At the same time, the adhesive fully penetrates into the pores of the modified aramid fiber paper and the modified mica paper to form an overall dense composite material, improving the tensile strength of the composite material and resulting in good electrical properties.

According to the second method for preparing the corona-resistant mica/aramid fiber blended paper for the new energy vehicle according to the present application, by adopting wet sheet formation and high-temperature hot-pressing molding and defining the hot-pressing temperature, the adhesive is melted and softened and fully penetrates into the gaps between the chopped fibers and the fibrids to be bonded into an overall dense structure, improving the strength of the blended paper, avoiding problems such as delamination and powder shedding, and resulting in good interleaving processability and electrical properties.

### BRIEF DESCRIPTION OF THE DRAWINGS

FIG. 1 is a schematic structural diagram of a corona-resistant mica/aramid fiber composite material for a new energy vehicle according to an example of the present application.

FIG. 2 is a schematic structural diagram of a corona-resistant mica/aramid fiber blended paper for the new energy vehicle according to an example of the present application.

Description of reference numerals in the drawings:
11: modified aramid fiber powder; 12: adhesive; 13: modified mica paper;
21: modified aramid fiber; 22: adhesive; and, 23: modified mica powder.

### DETAILED DESCRIPTION

The present application will be described in detail below in conjunction with examples, but the present application is not limited to these examples.

Unless otherwise defined, all professional and scientific terms used herein have the same meaning as commonly understood by those skilled in the art. The reagents or raw materials used in the present invention can all be obtained through conventional channels. Unless otherwise specified, the reagents or raw materials used in the present invention are used in the conventional manner in the art or according to the product instructions. In addition, any methods and materials similar or equivalent to the described content can be applied to the methods of the present invention. The preferred implementations and materials in this patent are only for demonstration purposes.

### Experimental Raw Materials

1. Mica powders with three particle sizes: wet grinding is performed using a ball mill to prepare mica raw materials with different particle sizes. The ball-to-material ratio is controlled to be 4:1, the mass ratio of small and medium balls is 1:1, the rotation speed is set to 300 rmp, and a laser particle size analyzer is used to measure the particle size and particle size distribution of the mica to prepare mica pulps with three different particle sizes.

2. Instruments: ball mill: TCXQM-2, Tencan Powder Co., Ltd.; laser particle size analyzer: BT-9300H, Bettersize Instrument Co., Ltd.; press: CHYZ-01, Chuchuang Electromechanical; tensile strength tester: SE-062, Lorentzen & Wettre, Sweden; disintegrator: ZQS4, Lorentzen & Wettre, Sweden; and paper sheet former, PY-Y814B, Shenzhen Puyun.

3. Reagents: mica: Pamica Electrical Engineering Material Co., Ltd., Hubei; silane coupling agent A171, Momentive, USA; methyl methacrylate, Shandong Xinyingshun New Material Co., Ltd.; benzoyl peroxide, Chinasun Specialty Products Co., Ltd.; and aramid fiber: Teijin, Japan.

The present application provides two types of mica/aramid fiber composite materials. A first composite material can be regarded as a composite paper with a multi-layer structure, and a second composite material can be regarded as a blended paper without a multi-layer structure or with a difficult-to-distinguish layered structure.

The mica/aramid fiber composite material according to the present application includes a modified aramid fiber material, an adhesive and a modified mica material. Specifically, for the first composite material A, the modified aramid fiber material is modified aramid fiber paper, and the modified mica material is modified mica paper; and for the second composite material B, the modified aramid fiber material is modified aramid fiber, and the modified mica material is modified mica powder.

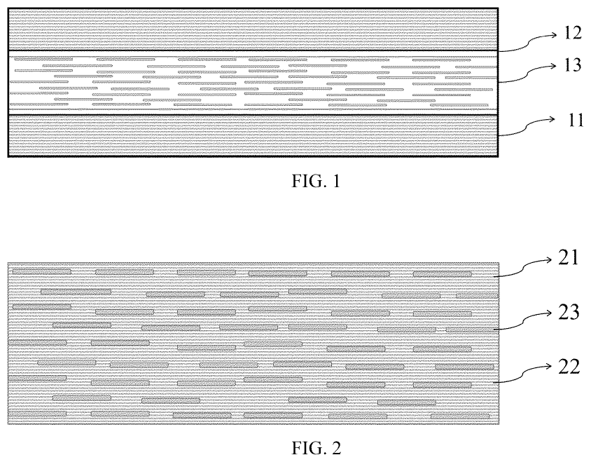

First, in conjunction with FIG. 1, the first mica/aramid fiber composite material according to the present application is described.

### Example A1: Composite Material A1#

The composite material A1# was prepared from the following raw materials in percentage by weight: 40% of modified aramid fiber paper, 5% of adhesive and 40% of modified mica paper. The adhesive was an FEP-fluorinated ethylene propylene copolymer (F46, a copolymer of tetrafluoroethylene and hexafluoropropylene).

The modified mica paper was prepared from the following raw materials: mica powder, a hydrochloric acid solution, ethanol, a silane coupling agent, methyl methacrylate, an initiator and methylbenzene. The mica powder consisted of a first mica powder, a second mica powder and a third mica powder. The particle size of the first mica powder was 90 μm, the particle size of the second mica powder was 130 μm, and the particle size of the third mica powder was 200 μm. The weight ratio of the first mica powder, the second mica powder and the third mica powder was 1:3:3 in sequence. The weight ratio of the silane coupling agent to the mica powder is 0.05:1. The weight ratio of the mica powder to methyl methacrylate and the initiator is 1:0.1:0.002 in sequence. The weight ratio of the mica powder to ethanol and methylbenzene is 1:6:5 in sequence.

The method for preparing the modified mica paper included the following steps:

adding the silane coupling agent A171 into ethanol, and adjusting the pH value to 4 by using the hydrochloric acid solution; then adding the mica powder, heating to 60 °C and stirring for 1 h; after being filtered, washed and dried, adding the mixture into methylbenzene, adding methyl methacrylate and benzoyl peroxide simultaneously for reaction at 70 °C for 2 h, and after filtering, drying at 110 °C for 0.5 h; and adding water and stirring evenly to form a pulp with a mass concentration of 3%, and performing sheet formation through a paper sheet former to obtain the modified mica paper.

Where, the modified aramid fiber paper was prepared from a meta-aramid chopped fiber and a meta-aramid fibrid. The lengths of both the meta-aramid chopped fiber and the meta-aramid fibrid were 2 mm, and the weight ratio of the meta-aramid chopped fiber to the meta-aramid fibrid was 1:2.

The method for preparing the modified aramid fiber paper included the following steps:
disintegrating and dispersing the meta-aramid chopped fiber and the meta-aramid fibrid, and adding water to make a slurry with a mass concentration of 0.1%; and after ultrasonic treatment, performing sheet formation through the paper sheet former to obtain the modified aramid fiber paper, wherein the thickness of the aramid fiber paper was 0.05 mm; the ultrasonic treatment step was that the ultrasonic treatment was performed for a total of 6 min with 10 s each time and an interval of 3 s; and, the ultrasonic parameters were a frequency of 10 kHz and a power of 500 W.

The method for preparing the composite material A1# included the following steps:
(1) unwinding two rolls of the modified aramid fiber paper, and coating the adhesive on surfaces thereof separately;
(2) unwinding the modified mica paper, first attaching the modified mica paper to one modified aramid fiber paper coated with the adhesive, then attaching the other modified aramid fiber paper coated with the adhesive to the other side of the modified mica paper, and oven-drying; and
(3) performing a hot-pressing on a dried composite material A through a hot roller to finally obtain the corona-resistant mica/aramid fiber composite material for a new energy vehicle A1# with a thickness of 0.25 mm.

An oven-drying temperature was 120 °C, a hot-pressing temperature was 270 °C, and a hot-pressing pressure was 20 MPa.

### Example A2: Composite Material A2#

The composite material A2# was prepared from the following raw materials in percentage by weight: 50% of modified aramid fiber paper, 10% of adhesive and 40% of modified mica paper. The adhesive was an FEP-fluorinated ethylene propylene copolymer (F46, a copolymer of tetrafluoroethylene and hexafluoropropylene).

Where, the modified mica paper was prepared from the following raw materials: mica powder, a hydrochloric acid solution, ethanol, a silane coupling agent, methyl methacrylate, an initiator and methylbenzene. The mica powder consisted of a first mica powder, a second mica powder and a third mica powder. The particle size of the first mica powder was 110 μm, the particle size of the second mica powder was 150 μm, and the particle size of the third mica powder was 230 μm. The weight ratio of the first mica powder, the second mica powder and the third mica powder was 1:5:5 in sequence. The weight ratio of the silane coupling agent to the mica powder is 0.08:1. The weight ratio of the mica powder to methyl methacrylate and the initiator is 1:0.15:0.005 in sequence. The weight ratio of the mica powder to ethanol and methylbenzene is 1:8:8 in sequence. The method for preparing the modified mica paper included the following steps: adding the silane coupling agent A171 into ethanol, and adjusting the pH value to 4 by using the hydrochloric acid solution, then adding the mica powder, heating to 80 °C and stirring for 3 h, after being filtered, washed and dried, adding the mixture into methylbenzene, adding methyl methacrylate and benzoyl peroxide simultaneously for reaction at 90 °C for 4 h, and after filtering, drying at 130 °C for 2 h, adding water and stirring evenly to form a pulp with a mass concentration of 4%, and performing sheet formation through a paper sheet former to obtain the modified mica paper.

Where, the modified aramid fiber paper was prepared from a meta-aramid chopped fiber and a meta-aramid fibrid. The lengths of both the meta-aramid chopped fiber and the meta-aramid fibrid were 3 mm, and the weight ratio of the meta-aramid chopped fiber to the meta-aramid fibrid was 1:2.5. The method for preparing the modified aramid fiber paper included the following steps: disintegrating and dispersing the meta-aramid chopped fiber and the meta-aramid fibrid, and adding water to make a slurry with a mass concentration of 0.3%; and after ultrasonic treatment, performing sheet formation through the paper sheet former to obtain the modified aramid fiber paper. The thickness of the aramid fiber paper was 0.05 mm. The ultrasonic treatment step was that the ultrasonic treatment was performed for a total of 9 min with 10 s each time and an interval of 3 s; and the ultrasonic parameters were a frequency of 20 kHz and a power of 500 W.

The method for preparing the composite material A2# included the following steps:
(1) unwinding two rolls of the modified aramid fiber paper, and coating the adhesive on surfaces thereof separately;
(2) unwinding the modified mica paper, first attaching the modified mica paper to one modified aramid fiber paper coated with the adhesive, then attaching the other modified aramid fiber paper coated with the adhesive to the other side of the modified mica paper, and oven-drying; and
(3) performing a hot-pressing on a dried composite material A through a hot roller to finally obtain the corona-resistant mica/aramid fiber composite material for a new energy vehicle A2# with a thickness of 0.25 mm.

An oven-drying temperature was 120 °C, a hot-pressing temperature was 265 °C, and a hot-pressing pressure was 20 MPa.

### Example A3: Composite Material A3#

The composite material A3# was prepared from the following raw materials in percentage by weight: 60% of modified aramid fiber paper, 20% of adhesive and 40% of modified mica paper. The adhesive was a PFA-tetrafluoroethylene-perfluoroalkoxy vinyl ether copolymer.

Where, the modified mica paper was prepared from the following raw materials: mica powder, a hydrochloric acid solution, ethanol, a silane coupling agent, methyl methacrylate, an initiator and methylbenzene. The mica powder consisted of a first mica powder, a second mica powder and a third mica powder. The particle size of the first mica powder was 100 μm, the particle size of the second mica powder was 140 μm, and the particle size of the third mica powder was 220 μm. The weight ratio of the first mica powder, the second mica powder and the third mica powder was 1:4:4 in sequence. The weight ratio of the silane coupling agent to the mica powder is 0.06:1. The weight ratio of the mica powder to methyl methacrylate and the initiator is 1:0.12:0.003 in sequence. The weight ratio of the mica powder to ethanol and methylbenzene is 1:7:6 in sequence. The method for preparing the modified mica paper included the following steps: adding the silane coupling agent A171 into ethanol, and adjusting the pH value to 4 by using the hydrochloric acid solution, then adding the mica powder, heating to 70 °C and stirring for 2 h, after being filtered, washed and dried, adding the mixture into methylbenzene, adding methyl methacrylate and benzoyl peroxide simultaneously for reaction at 80 °C for 3 h, and after filtering, drying at 120 °C for 1 h, adding water and stirring evenly to form a pulp with a mass concentration of 5%, and performing sheet formation through a paper sheet former to obtain the modified mica paper.

Where, the modified aramid fiber paper was prepared from a meta-aramid chopped fiber and a meta-aramid fibrid. The lengths of both the meta-aramid chopped fiber and the meta-aramid fibrid were 2 mm, and the weight ratio of the meta-aramid chopped fiber to the meta-aramid fibrid was 1:2.2. The method for preparing the modified aramid fiber paper included the following steps: disintegrating and dispersing the meta-aramid chopped fiber and the meta-aramid fibrid, and adding water to make a slurry with a mass concentration of 0.5%; and after ultrasonic treatment, performing sheet formation through the paper sheet former to obtain the modified aramid fiber paper. The thickness of the aramid fiber paper was 0.05 mm. The ultrasonic treatment step was that the ultrasonic treatment was performed for a total of 7 min with 10 s each time and an interval of 3 s; and the ultrasonic parameters were a frequency of 15 kHz and a power of 500 W.

The method for preparing the composite material A3# included the following steps:
(1) unwinding two rolls of the modified aramid fiber paper, and coating the adhesive on surfaces thereof separately;
(2) unwinding the modified mica paper, first attaching the modified mica paper to one modified aramid fiber paper coated with the adhesive, then attaching the other modified aramid fiber paper coated with the adhesive to the other side of the modified mica paper, and oven-drying; and
(3) performing a hot-pressing on a dried composite material A through a hot roller to finally obtain the corona-resistant mica/aramid fiber composite material for a new energy vehicle A3# with a thickness of 0.25 mm.

An oven-drying temperature was 120 °C, a hot-pressing temperature was 310 °C, and a hot-pressing pressure was 20 MPa.

### Example A4: Composite Material A4#

Example A4 differed from Example A1 in that the adhesive in Example A4 was a fluorinated ethylene propylene copolymer (F46, a copolymer of tetrafluoroethylene and hexafluoropropylene) and polyetheretherketone with a weight ratio of 3:1, and the rest were the same.

### Comparative Example A1: Comparative Composite Material A1#

Comparative Example A1 differed from Example A3 in that the adhesive in Comparative Example A1 was methylated amino resin, and the rest were the same.

### Comparative Example A2: Comparative Composite Material A2#

Comparative Example A2 differed from Example A3 in that the aramid fiber in Comparative Example A2 was not modified, and the rest were the same.

### Comparative Example A3: Comparative Composite Material A3#

Comparative Example A3 differed from Example A3 in that the mica powder in Comparative Example A3 consisted of two types of mica powder with particle sizes of 50 μm and 90 μm in a weight ratio of 1:3, and the rest were the same.

### Comparative Example A4: Comparative Composite Material A4#

Comparative Example A4 differed from Example A3 in that the weight ratio of the first mica powder, the second mica powder and the third mica powder in Comparative Example A4 was 1:1.5:1.2 in sequence, and the rest were the same.

### Comparative Example A5: Comparative Composite Material A5#

Comparative Example A5 differed from Example A3 in that the weight ratio of the silane coupling agent to the mica powder in Comparative Example A5 was 0.12:1, and the rest were the same.

### Comparative Example A6: Comparative Composite Material A6#

Comparative Example A6 differed from Example A3 in that only the silane coupling agent KH550 was used to modify the mica powder in Comparative Example A6, and the rest were the same.

### Comparative Example A7: Comparative Composite Material A7#

Comparative Example A7 differed from Example A3 in that a para-aramid fibrid was used as the aramid fiber in Comparative Example A7, and the rest were the same.

### Comparative Example A8: Comparative Composite Material A8#

Comparative Example A8 differed from Example A3 in that both the meta-aramid chopped fiber and the meta-aramid fibrid in Comparative Example A8 had a length of 5 mm, and the rest were the same.

### Comparative Example A9: Comparative Composite Material A9#

Comparative Example A9 differed from Example A3 in that the weight ratio of the meta-aramid chopped fiber to the para-aramid fibrid in Comparative Example A9 was 1:1, and the rest were the same.

### Comparative Example A10: Comparative Composite Material A10#

Comparative Example A10 differed from Example A3 in that the hot-pressing temperature in Comparative Example A10 was 360 °C, and the rest were the same.

### Comparative Example A11: Comparative Composite Material A11#

Comparative Example A11 was a pure meta-aramid fiber paper with a thickness of 0.25 mm.

### Comparative Example A12: Comparative Composite Material A12#

Comparative Example A12 was a composite material A (the commercial material name was NHN) prepared by using polyurethane as the adhesive and compositing 0.05-mm-thick meta-aramid fiber paper on both sides of a polyimide film, with a thickness of 0.25 mm.

### Experimental Examples

### 1. Electrical Properties

Breakdown voltage: tests were conducted according to GB/T 1408.1-2006. The thickness of the sample was 0.25 mm. A cylindrical electrode system with a diameter of Φ25 mm/Φ75 mm was adopted. The number of tests was 5 times, and the average value was taken.

PDIV (partial discharge inception voltage): tests were conducted according to GB/T 7354-2018. The frequency of the alternating voltage was 50 Hz; the voltage rise rate was 50 V/s; a partial discharge quantity of 10 pC was taken as the inception discharge voltage point; and the experimental temperature was 21-25 °C, and the humidity was 45-55%.

### 2. Temperature Resistance Experiment

Experimental method: Tests were conducted according to GB/T 4074.7-2009, and the thermal resistance class of the material was evaluated using the three-point method.

### 3. Tensile Strength

Experimental method: the tensile strength was determined according to GB/T 20629.2-2013 and GB/T 5591.2-2017.

### 4. Square-Wave Corona Resistance Life

Experimental method: tests were conducted according to T/CEEIA 415-2019. Test conditions: peak-to-peak voltage Vp-p=3000 V, temperature 155±3 °C, frequency=20 kHz, rise time 100±10 ns, and duty cycle 50%.

Samples were taken from Composite Materials A1#-4# and Comparative Composite Materials A1#-12# separately for the above four experimental tests. The experimental results are shown in Table 1.

| | Item | | | | |
|---|---|---|---|---|---|
| | | | | | Square-wave |
| | Breakdown | | Aging | Tensile | corona |
| | voltage | PDIV | temperature | strength | resistance |
| Serial number | (kV) | (kV) | (°C) | (N/cm) | life (h) |
| Composite Material | 12.8 | 1.21 | 240 | 82 | 123 |
| A1# | | | | | |
| Composite Material | 13.2 | 1.19 | 240 | 79 | 110 |
| A2# | | | | | |
| Composite Material | 12.6 | 1.32 | 250 | 86 | 152 |
| A3# | | | | | |
| Composite Material | 12.3 | 1.24 | 230 | 78 | 129 |
| A4# | | | | | |
| Comparative | 9.2 | 0.93 | 180 | 56 | 21 |
| Composite Material | | | | | |
| A1# | | | | | |
| Comparative | 9.5 | 1.05 | 240 | 65 | 73 |
| Composite Material | | | | | |
| A2# | | | | | |
| Comparative | 9.8 | 1.02 | 240 | 71 | 119 |
| Composite Material | | | | | |
| A3# | | | | | |
| Comparative | 9.5 | 1.18 | 240 | 73 | 112 |
| Composite Material | | | | | |
| A4# | | | | | |
| Comparative | 10.3 | 1.12 | 240 | 75 | 107 |
| Composite Material | | | | | |
| A5# | | | | | |
| Comparative | 10.8 | 1.15 | 240 | 80 | 82 |
| Composite Material | | | | | |
| A6# | | | | | |
| Comparative | 10.8 | 1.13 | 240 | 88 | 109 |
| Composite Material | | | | | |
| A7# | | | | | |
| Comparative | 11.7 | 1.17 | 240 | 69 | 118 |
| Composite Material | | | | | |
| A8# | | | | | |
| Comparative | 10.3 | 1.12 | 230 | 85 | 117 |
| Composite Material | | | | | |
| A9# | | | | | |
| Comparative | 11.8 | 1.10 | 240 | 81 | 110 |
| Composite Material | | | | | |
| A10# | | | | | |
| Comparative | 9.0 | 1.05 | 220 | 285 | 10 |
| Composite Material | | | | | |
| A11# | | | | | |
| Comparative | 15.9 | 1.02 | 180 | 220 | 8 |
| Composite Material | | | | | |
| A12# | | | | | |

It can be seen from the above experimental data that Composite Materials A1#-4# prepared through the raw materials and methods defined in the present application have good electrical properties, long square-wave corona resistance life, excellent high-temperature resistance and excellent mechanical properties.

Comparative Composite Material A1# used a commonly used commercially available adhesive. The final result shows that its electrical properties are average and its high-temperature resistance is also average. In Comparative Composite Material A2#, the aramid fiber was not modified. The final result shows that its electrical properties are average. The reason analyzed is that the aramid fiber has high inertness and poor interfacial bonding with other matrix materials.

In Comparative Composite Material A3#, the particle size of the mica powder was smaller than the range defined in the present application. The final result shows that its electrical properties are average and the breakdown voltage is low. The reason analyzed is that mica with a small particle size produces more mica fragments. When added to the paper, most of them act as the “sediment” component. The irregular arrangement leads to a loose paper structure, an increase in thickness, damage to the mixed structure of the paper, a decrease in the mechanical properties of the paper and an increase in paper pores. When the paper is subjected to an external voltage, the electron beam is more likely to break down the paper due to the reduced high-insulation barrier of large-flake mica in the Z-direction.

In Comparative Composite Material A4#, the proportion of mica powder with a small particle size exceeded the range defined in the present application. The final result shows that its electrical properties are average. The reason analyzed is that as the amount of mica with a smaller particle size increases, the integrity of the mica lamellae is damaged. The size in the longitudinal structure increases, and fine particles increase and gradually aggregate and pile up. The arrangement of mica flakes changes from flat layering to inclined positioning, resulting in a decrease in mechanical properties. At the same time, due to the damage of the mica lamellar structure, the small-particle-size mica with a large proportion appears granular. The particle accumulation produces a large number of pores, which limits the insulation effect of mica. When the paper is subjected to electrical breakdown, the current encounters less resistance and the current path is shorter, resulting in a decrease in the overall insulation performance of the paper.

In Comparative Composite Material A5#, the ratio of the silane coupling agent to the mica powder exceeded the range defined in the present application. The final result shows that its electrical properties are average. The reason analyzed is that if the amount of the coupling agent is too large, the coupling efficiency will be reduced due to the condensation reaction, the grafting rate will be low, and the modification effect will be poor. If the amount of the coupling agent is small, there will be less coupling agent grafted on the surface.

In Comparative Composite Material A6#, only the silane coupling agent was used to modify the mica powder. The final result shows that its electrical properties are average. The reason analyzed is that the dispersion performance after modification is still limited, and the interfacial bonding performance with other materials is not high.

The Comparative Composite Material A7# used a para-aramid fibrid. The final result shows that its mechanical properties are good, but its electrical properties are average. The reason analyzed is that the para-molecular structure shows excellent mechanical properties, but relatively poor electrical properties compared with the meta-structure. At the same time, its fibrid has poor coating performance on a chopped fiber.

In Comparative Composite Material A8#, the fiber length used exceeded the range defined in the present application. The final result shows that its electrical properties are average. The reason analyzed is that the longer fibers increase the probability of mutual entanglement between fibers, which is not conducive to dispersion and increases the non-uniformity of the hot-pressed composite paper, thus affecting the overall strength of the paper.

In Comparative Composite Material A9#, the ratio of the fibrid to the chopped fiber was less than the range defined in the present application. The final result shows that its electrical properties are average. The reason analyzed is that the chopped fiber interspersed in the paper structure leads to the easy formation of pores in the paper. A smaller proportion of the fibrid results in poor bonding with the chopped fiber, making it difficult to exert its electrical and thermal properties.

In Comparative Composite Material A10#, the hot-pressing temperature was higher than the range defined in the present application. The final result shows that its electrical properties are average. The reason analyzed is that the high temperature leads to the aging of the raw materials and a decrease in the bonding force between the aramid fiber and fibrid. The Comparative Composite Materials A11#-12# are the commonly used commercially available composite material A, with average high-temperature resistance and short corona resistance life.

Next, in conjunction with FIG. 2, the second mica/aramid fiber composite material according to the present application is described.

### Example B1: Blended Paper 1#

Blended Paper 1# was prepared from the following raw materials: a modified aramid fiber, an adhesive and modified mica powder. The weight ratio of the modified aramid fiber to the modified mica powder was 0.1:1. The amount of the adhesive added was 5% of the total weight of the modified aramid fiber and the modified mica powder. The adhesive was a PFA-tetrafluoroethylene-perfluoroalkoxy vinyl ether copolymer.

Where, the modified mica powder was prepared from the following raw materials: mica powder, a hydrochloric acid solution, ethanol, a silane coupling agent, methyl methacrylate, an initiator and methylbenzene. The mica powder consisted of a first mica powder, a second mica powder and a third mica powder. The particle size of the first mica powder was 90 μm, the particle size of the second mica powder was 130 μm, and the particle size of the third mica powder was 200 μm. The weight ratio of the first mica powder, the second mica powder and the third mica powder was 1:3:3 in sequence. The weight ratio of the silane coupling agent to the mica powder is 0.05:1. The weight ratio of the mica powder to methyl methacrylate and the initiator is 1:0.1:0.002 in sequence. The weight ratio of the mica powder to ethanol and methylbenzene is 1:6:5 in sequence.

The method for preparing the modified mica powder included the following steps:
adding the silane coupling agent A171 into ethanol, and adjusting the pH value to 4 by using the hydrochloric acid solution;
then adding the mica powder, heating to 60 °C, stirring for 1 h, and filtering, washing and drying; and
then adding the mixture into methylbenzene, adding methyl methacrylate and benzoyl peroxide simultaneously for reaction at 70 °C for 2 h, and after filtrating, drying at 110 °C for 0.5 h to obtain the modified mica powder.

The modified aramid fiber was prepared from a meta-aramid chopped fiber and a meta-aramid fibrid. The lengths of both the meta-aramid chopped fiber and the meta-aramid fibrid were 2 mm, and the weight ratio of the meta-aramid chopped fiber to the meta-aramid fibrid was 1:2.

The method for preparing the modified aramid fiber included the following steps:
disintegrating and dispersing the meta-aramid chopped fiber and the meta-aramid fibrid to form a slurry, and
performing ultrasonic treatment and drying to obtain the modified aramid fiber. The ultrasonic treatment step was that the ultrasonic treatment was performed for a total of 6 min with 10 s each time and an interval of 3 s; and the ultrasonic parameters were a frequency of 10 kHz and a power of 500 W.

The method for preparing Blended Paper 1# included the following steps:
(1) mixing the modified mica powder with water to make a pulp with a mass concentration of 2%, and mixing the modified aramid fiber with water to make a pulp with a mass concentration of 0.2%;
(2) mixing and stirring the modified mica powder pulp, the modified aramid fiber pulp and the adhesive evenly; and
(3) adding a mixed pulp into a paper sheet former for sheet formation, after pressing, oven-drying, and then performing a hot-pressing through a hot roller to finally obtain a corona-resistant mica/aramid fiber blended paper for a new energy vehicle 1# with a thickness of 0.25 mm.

Where, pressing time was 5 min, and a pressure was 300 kPa; and a hot-pressing temperature was 310 °C, and a hot-pressing pressure was 20 MPa.

### Example B2: Blended Paper 2#

Blended Paper 2# was prepared from the following raw materials: a modified aramid fiber, an adhesive and modified mica powder. The weight ratio of the modified aramid fiber to the modified mica powder was 0.5:1. The amount of the adhesive added was 10% of the total weight of the modified aramid fiber and the modified mica powder. The adhesive was an FEP-fluorinated ethylene propylene copolymer (F46, a copolymer of tetrafluoroethylene and hexafluoropropylene).

Where, the modified mica powder was prepared from the following raw materials: mica powder, a hydrochloric acid solution, ethanol, a silane coupling agent, methyl methacrylate, an initiator and methylbenzene. The mica powder consisted of a first mica powder, a second mica powder and a third mica powder. The particle size of the first mica powder was 110 μm, the particle size of the second mica powder was 150 μm, and the particle size of the third mica powder was 230 μm. The weight ratio of the first mica powder, the second mica powder and the third mica powder was 1:5:5 in sequence. The weight ratio of the silane coupling agent to the mica powder is 0.08:1. The weight ratio of the mica powder to methyl methacrylate and the initiator is 1:0.15:0.005 in sequence. The weight ratio of the mica powder to ethanol and methylbenzene is 1:8:8 in sequence. The method for preparing the modified mica powder included the following steps: adding the silane coupling agent A171 into ethanol, and adjusting the pH value to 4 by using the hydrochloric acid solution, then adding the mica powder, heating to 80 °C and stirring for 3 h, after being filtered, washed and dried, adding the mixture into methylbenzene, adding methyl methacrylate and benzoyl peroxide simultaneously for reaction at 90 °C for 4 h, and after filtering, drying at 130 °C for 2 h to obtain the modified mica powder.

Where, the modified aramid fiber was prepared from a meta-aramid chopped fiber and a meta-aramid fibrid. The lengths of both the meta-aramid chopped fiber and the meta-aramid fibrid were 3 mm, and the weight ratio of the meta-aramid chopped fiber to the meta-aramid fibrid was 1:2.5. The method for preparing the modified aramid fiber included the following steps: disintegrating and dispersing the meta-aramid chopped fiber and the meta-aramid fibrid to make a slurry, and performing ultrasonic treatment and drying to obtain the modified aramid fiber. The ultrasonic treatment step was that the ultrasonic treatment was performed for a total of 9 min with 10 s each time and an interval of 3 s; and the ultrasonic parameters were a frequency of 20 kHz and a power of 500 W.

The method for preparing Blended Paper 2# included the following steps:
(1) mixing the modified mica powder with water to make a pulp with a mass concentration of 2%, and mixing the modified aramid fiber with water to make a pulp with a mass concentration of 1%;
(2) mixing and stirring the modified mica powder pulp, the modified aramid fiber pulp and the adhesive evenly; and
(3) adding a mixed pulp into a paper sheet former for sheet formation, after pressing, oven-drying, and then performing a hot-pressing with a plate press to finally obtain a corona-resistant mica/aramid fiber blended paper for a new energy vehicle 2# with a thickness of 0.25 mm.

Pressing time was 5 min, and a pressure was 300 kPa; and a hot-pressing temperature was 265 °C, and a hot-pressing pressure was 20 MPa.

### Example B3: Blended Paper 3#

Blended Paper 3# was prepared from the following raw materials: a modified aramid fiber, an adhesive and modified mica powder. The weight ratio of the modified aramid fiber to the modified mica powder was 0.3:1. The amount of the adhesive added was 8% of the total weight of the modified aramid fiber and the modified mica powder. The adhesive was a PFA-tetrafluoroethylene-perfluoroalkoxy vinyl ether copolymer.

Where, the modified mica powder was prepared from the following raw materials: mica powder, a hydrochloric acid solution, ethanol, a silane coupling agent, methyl methacrylate, an initiator and methylbenzene. The mica powder consisted of a first mica powder, a second mica powder and a third mica powder. The particle size of the first mica powder was 100 μm, the particle size of the second mica powder was 140 μm, and the particle size of the third mica powder was 220 μm. The weight ratio of the first mica powder, the second mica powder and the third mica powder was 1:4:4 in sequence. The weight ratio of the silane coupling agent to the mica powder is 0.06:1. The weight ratio of the mica powder to methyl methacrylate and the initiator is 1:0.12:0.003 in sequence. The weight ratio of the mica powder to ethanol and methylbenzene is 1:7:6 in sequence. The method for preparing the modified mica powder included the following steps: adding the silane coupling agent A171 into ethanol, and adjusting the pH value to 4 by using the hydrochloric acid solution, then adding the mica powder, heating to 70 °C and stirring for 2 h, after being filtered, washed and dried, adding the mixture into methylbenzene, adding methyl methacrylate and benzoyl peroxide simultaneously for reaction at 80 °C for 3 h, and after filtering, drying at 120 °C for 1 h to obtain the modified mica powder.

Where, the modified aramid fiber was prepared from a meta-aramid chopped fiber and a meta-aramid fibrid. The lengths of both the meta-aramid chopped fiber and the meta-aramid fibrid were 2 mm, and the weight ratio of the meta-aramid chopped fiber to the meta-aramid fibrid was 1:2.2. The method for preparing the modified aramid fiber included the following steps: disintegrating and dispersing the meta-aramid chopped fiber and the meta-aramid fibrid to make a slurry, and performing ultrasonic treatment and drying to obtain the modified aramid fiber. The ultrasonic treatment step was that the ultrasonic treatment was performed for a total of 7 min with 10 s each time and an interval of 3 s; and the ultrasonic parameters were a frequency of 15 kHz and a power of 500 W.

The method for preparing Blended Paper 3# included the following steps:
(1) mixing the modified mica powder with water to make a pulp with a mass concentration of 2%, and mixing the modified aramid fiber with water to make a pulp with a mass concentration of 0.4%;
(2) mixing and stirring the modified mica powder pulp, the modified aramid fiber pulp and the adhesive evenly; and
(3) adding a mixed pulp into a paper sheet former for sheet formation, after pressing, oven-drying, and then performing a hot-pressing with a plate press to finally obtain a corona-resistant mica/aramid fiber blended paper for a new energy vehicle 3# with a thickness of 0.25 mm.

Where, pressing time was 5 min, and a pressure was 300 kPa; and a hot-pressing temperature was 302 °C, and a hot-pressing pressure was 20 MPa.

### Example B4: Blended Paper 4#

Example B4 differed from Example B1 in that the adhesive in Example B4 was FEP-fluorinated ethylene propylene copolymer (F46, a copolymer of tetrafluoroethylene and hexafluoropropylene) and PEEK-polyetheretherketone with a weight ratio of 3:1, and the rest were the same.

### Comparative Example B1: Comparative Blended Paper 1#

Comparative Example B1 differed from Example B3 in that the adhesive in Comparative Example B1 was methylated amino resin, and the rest were the same.

### Comparative Example B2: Comparative Blended Paper 2#

Comparative Example B2 differed from Example B3 in that the aramid fiber in Comparative Example B2 was not modified, and the rest were the same.

### Comparative Example B3: Comparative Blended Paper 3#

Comparative Example B3 differed from Example B3 in that the weight ratio of the modified aramid fiber to the modified mica powder in Comparative Example B3 is 1.2:1, and the rest were the same.

### Comparative Example B4: Comparative Blended Paper 4#

Comparative Example B4 differed from Example B3 in that the mica powder in Comparative Example B4 consisted of two types of mica powder with particle sizes of 50 μm and 90 μm in a weight ratio of 1:3, and the rest were the same.

### Comparative Example B5: Comparative Blended Paper 5#

Comparative Example B5 differed from Example B3 in that the weight ratio of the first mica powder, the second mica powder and the third mica powder in Comparative Example B5 was 1:1.5:1.2 in sequence, and the rest were the same.

### Comparative Example B6: Comparative Blended Paper 6#

Comparative Example B6 differed from Example B3 in that the weight ratio of the silane coupling agent to the mica powder in Comparative Example B6 was 0.12:1, and the rest were the same.

### Comparative Example B7: Comparative Blended Paper 7#

Comparative Example B7 differed from Example B3 in that only the silane coupling agent KH550 was used to modify the mica powder in Comparative Example B7, and the rest were the same.

### Comparative Example B8: Comparative Blended Paper 8#

Comparative Example B8 differed from Example B3 in that a para-aramid fibrid was used as the aramid fiber in Comparative Example B8, and the rest were the same.

### Comparative Example B9: Comparative Blended Paper 9#

Comparative Example B9 differed from Example B3 in that both the meta-aramid chopped fiber and the meta-aramid fibrid in Comparative Example B9 had a length of 5 mm, and the rest were the same.

### Comparative Example B10: Comparative Blended Paper 10#

Comparative Example B10 differed from Example B3 in that the weight ratio of the meta-aramid chopped fiber to the meta-aramid fibrid in Comparative Example B10 was 1:1, and the rest were the same.

### Comparative Example B11: Comparative Blended Paper 11#

Comparative Example B11 differed from Example B3 in that the hot-pressing temperature in Comparative Example B11 was 380 °C, and the rest were the same.

### Comparative Example B12: Meta-Aramid Fiber Paper

Comparative Example B12 is a commercially available pure meta-aramid fiber paper with a thickness of 0.25 mm.

### Experimental Examples

### 1. Electrical Properties

Breakdown voltage: tests were conducted according to GB/T 1408.12006. The thickness of the sample was 0.25 mm. A cylindrical electrode system with a diameter of Φ25 mm/Φ75 mm was adopted. The number of tests was 5 times, and the average value was taken.

PDIV (partial discharge inception voltage): tests were conducted according to GB/T 7354-2018. The frequency of the alternating voltage was 50 Hz; the voltage rise rate was 50 V/s; a partial discharge quantity of 10 pC was taken as the inception discharge voltage point; and the experimental temperature was 21-25 °C, and the humidity was 45-55%.

### 2. Temperature Resistance Experiment

Experimental method: Tests were conducted according to GB/T 4074.7-2009, and the thermal resistance class of the material was evaluated using the three-point method.

### 3. Tensile Strength

Experimental method: the tensile strength was determined according to GB/T 20629.2-2013 and GB/T 5591.2-2017.

### 4. Square-Wave Corona Resistance Life

Experimental method: tests were conducted according to T/CEEIA 415-2019. Test conditions: peak-to-peak voltage Vp-p=3000 V, temperature 155±3 °C, frequency=20 kHz, rise time 100±10 ns, and duty cycle 50%.

Samples were taken from Composite Materials B1#-4#, Comparative Composite Materials B1#-11# and Meta-aramid Fiber Paper separately for the above four experimental tests. The experimental results are shown in Table 2.

TABLE 2

| | Item | | | | |
|---|---|---|---|---|---|
| | | | | | Square-wave |
| | Breakdown | | Temperature | Tensile | corona |
| | voltage | PDIV | resistance | strength | resistance |
| Serial number | (kV) | (kV) | (°C) | (N/cm) | life (h) |
| Blended Paper 1# | 13.1 | 1.25 | 240 | 92 | 217 |
| Blended Paper 2# | 13.5 | 1.34 | 240 | 89 | 238 |
| Blended Paper 3# | 12.7 | 1.29 | 240 | 95 | 225 |
| Blended Paper 4# | 12.5 | 1.36 | 230 | 86 | 196 |
| Comparative | 8.5 | 0.91 | 180 | 56 | 13 |
| Blended Paper 1# | | | | | |
| Comparative | 9.2 | 1.05 | 230 | 67 | 39 |
| Blended Paper 2# | | | | | |
| Comparative | 8.7 | 1.02 | 230 | 73 | 52 |
| Blended Paper 3# | | | | | |
| Comparative | 8.5 | 0.87 | 230 | 75 | 49 |
| Blended Paper 4# | | | | | |
| Comparative | 9.2 | 1.07 | 230 | 70 | 53 |
| Blended Paper 5# | | | | | |
| Comparative | 10.1 | 1.03 | 240 | 72 | 63 |
| Blended Paper 6# | | | | | |
| Comparative | 9.6 | 1.10 | 230 | 66 | 38 |
| Blended Paper 7# | | | | | |
| Comparative | 8.5 | 0.96 | 240 | 95 | 32 |
| Blended Paper 8# | | | | | |
| Comparative | 11.3 | 1.12 | 230 | 65 | 105 |
| Blended Paper 9# | | | | | |
| Comparative | 9.8 | 1.02 | 230 | 72 | 64 |
| Blended Paper 10# | | | | | |
| Comparative | 9.4 | 1.05 | 220 | 68 | 47 |
| Blended Paper 11# | | | | | |
| Meta-aramid Fiber | 8.8 | 1.02 | 220 | 282 | 12 |
| Paper | | | | | |

It can be seen from the above experimental data that Blended Papers 1#-4# prepared through the raw materials and methods defined in the present application have good electrical properties, long square-wave corona resistance life, excellent high-temperature resistance and excellent mechanical properties.

Comparative Blended Paper 1# used a commonly used commercially available adhesive. The final result shows that its electrical properties are average and its high-temperature resistance is also average. In Comparative Blended Paper 2#, the aramid fiber was not modified. The final result shows that its electrical properties are average. The reason analyzed is that the aramid fiber has high inertness and poor interfacial bonding with other matrix materials.

In Comparative Blended Paper 3#, the ratio of the modified aramid fiber to the modified mica powder exceeded the range defined in the present application. The final result shows that its electrical properties are average. The reason analyzed is that the bonding state between the aramid fiber and the mica has reached saturation. Excessive fibers accumulate in the gaps formed by the mica flakes or on the surface of the flakes, resulting in an increase in the thickness of the paper. This leads to an uneven distribution of the electric field in the paper structure, and a large amount of heat cannot be dissipated, resulting in a decrease in the breakdown field strength.

In Comparative Blended Paper 4#, the particle size of the mica powder was smaller than the range defined in the present application. The final result shows that its electrical properties are average. The reason analyzed is that mica with a small particle size produces more mica fragments. When added to the paper, most of them act as the “sediment” component. The irregular arrangement leads to a decrease in the tightness of the fit between the mica and the fiber, a loose paper structure, an increase in thickness, damage to the mixed structure of the paper, a decrease in the mechanical properties of the paper and an increase in paper pores. When the paper is subjected to an external voltage, the electron beam is more likely to break down the paper due to the reduced high-insulation barrier of large-flake mica in the Z-direction.

In Comparative Blended Paper 5#, the proportion of mica powder with a small particle size exceeded the range defined in the present application. The final result shows that its electrical properties are average. The reason analyzed is that as the amount of mica with a smaller particle size increases, the integrity of the mica lamellae is damaged. The size in the longitudinal structure increases, and fine particles increase and gradually aggregate and pile up. The arrangement of mica flakes changes from flat layering to inclined positioning, resulting in a poor fit between the fibers and the mica and a decrease in mechanical properties. At the same time, due to the damage of the mica lamellar structure, the small-particle-size mica with a large proportion appears granular. The particle accumulation produces a large number of pores, which limits the insulation effect of mica. When the paper is subjected to electrical breakdown, the current encounters less resistance and the current path is shorter, resulting in a decrease in the overall insulation performance of the paper.

In Comparative Blended Paper 6#, the ratio of the silane coupling agent to the mica powder exceeded the range defined in the present application. The final result shows that its electrical properties are average. The reason analyzed is that if the amount of the coupling agent is too large, the coupling efficiency will be reduced due to the condensation reaction, the grafting rate will be low, and the modification effect will be poor. If the amount of the coupling agent is small, there will be less coupling agent grafted on the surface.

In Comparative Blended Paper 7#, only the silane coupling agent was used to modify the mica powder. The final result shows that its electrical properties are average. The reason analyzed is that the dispersion performance after modification is still limited, and the interfacial bonding strength with other materials is not high.

Comparative Blended Paper 8# used a para-aramid fibrid. The final result shows that its mechanical properties are good, but its electrical properties are average. The reason analyzed is that the para-molecular structure shows excellent mechanical properties, but relatively poor electrical properties compared with the meta-structure. At the same time, the fibrid has poor coating performance on a chopped fiber.

In Comparative Blended Paper 9#, the fiber length used exceeded the range defined in the present application. The final result shows that its electrical properties are average. The reason analyzed is that the longer fibers increase the probability of mutual entanglement between fibers, which is not conducive to dispersion and increases the non-uniformity of the hot-pressed composite paper, thus affecting the overall strength of the paper.

In Comparative Blended Paper 10#, the ratio of the fibrid to the chopped fiber was less than the range defined in the present application. The final result shows that its electrical properties are average. The reason analyzed is that the chopped fiber has no bonding force with the mica. At the same time, the chopped fiber has a relatively large thickness compared with the mica, and is interspersed in the paper structure, which has a certain destructive effect on the bonding between the fibrid and the mica, leading to the easy formation of pores in the paper. A smaller proportion of the fibrid results in poor bonding between the chopped fiber and the mica, making it difficult to exert their electrical and thermal properties.

In Comparative Blended Paper 11#, the hot-pressing temperature was higher than the range defined in the present application. The final result shows that its electrical properties are average. The reason analyzed is that the high temperature led to the aging of the raw materials and a decrease in the bonding force among the aramid fiber, the fibrid and the mica powder. Comparative Example B12, Meta-aramid Fiber Paper did not contain mica components. The final result shows that its electrical properties are average, its high-temperature resistance is average, but its mechanical properties are good.

The above are only the examples of the present application. The scope of protection of the present application is not limited by these specific examples, but is determined by the claims of the present application. For those skilled in the art, various changes and modifications can be made to the present application. Any modifications, equivalent substitutions, improvements, etc. made within the technical concept and principles of the present application shall be included within the scope of protection of the present application.

1. A corona-resistant mica/aramid fiber composite material for a new energy vehicle, wherein
raw materials for preparing the composite material comprise: a modified aramid fiber material, an adhesive and a modified mica material, wherein
the adhesive comprises one or more of a tetrafluoroethylene-perfluoroalkoxy vinyl ether copolymer, a fluorinated ethylene propylene copolymer, an ethylene-tetrafluoroethylene copolymer, polyetheretherketone and polyetherimide; and
the modified mica material is prepared from raw materials of: mica powder, a hydrochloric acid solution, ethanol, a silane coupling agent, methyl methacrylate, an initiator and methylbenzene, wherein the mica powder consists of first mica powder, second mica powder and third mica powder, a particle size of the first mica powder is 90-110 μm, a particle size of the second mica powder is 130-150 μm, and a particle size of the third mica powder is 200-230 μm; and a weight ratio of the first mica powder, the second mica powder and the third mica powder is 1:(3-5):(3-5) in sequence.

2. The corona-resistant mica/aramid fiber composite material for the new energy vehicle according to claim 1, wherein a weight ratio of the silane coupling agent to the mica powder is (0.05-0.08):1, a weight ratio of the mica powder to methyl methacrylate and the initiator is 1:(0.1-0.15):(0.002-0.005) in sequence, and a weight ratio of the mica powder to ethanol and methylbenzene is 1:(6-8):(5-8) in sequence.

3. The corona-resistant mica/aramid fiber composite material for the new energy vehicle according to claim 2, wherein a method for preparing the modified mica material comprises steps of:
S11, adding the silane coupling agent into ethanol, and adjusting a pH value to 4 by using the hydrochloric acid solution,
S12, adding the mica powder, heating to 60-80 °C, stirring for 1-3 h, and filtering, washing and drying, and
S13, adding the mixture into methylbenzene, adding methyl methacrylate and the initiator simultaneously for reaction at 70-90 °C for 2-4 h, and after filtering, drying at 110-130 °C for 0.5-2 h.

4. The corona-resistant mica/aramid fiber composite material for the new energy vehicle according to claim 3, wherein the silane coupling agent is A171, and the initiator is benzoyl peroxide.

5. The corona-resistant mica/aramid fiber composite material for the new energy vehicle according to claim 1, wherein the modified aramid fiber material is prepared from a meta-aramid chopped fiber and a meta-aramid fibrid, lengths of the meta-aramid chopped fiber and the meta-aramid fibrid are both 2-3 mm, and a weight ratio of the meta-aramid chopped fiber to the meta-aramid fibrid is 1:(2-2.5).

6. The corona-resistant mica/aramid fiber composite material for the new energy vehicle according to claim 5, wherein a method for preparing the modified aramid fiber material comprises steps of:
S21, disintegrating and dispersing the meta-aramid chopped fiber and the meta-aramid fibrid to form a slurry, and
S22, performing an ultrasonic treatment on the slurry.

7. The corona-resistant mica/aramid fiber composite material for the new energy vehicle according to claim 6, wherein the ultrasonic treatment step is to perform ultrasonic treatment for a total of 6-9 min with 10 s each time and an interval of 3 s; and ultrasonic parameters are a frequency of 10-20 kHz and a power of 500 W.

8. The corona-resistant mica/aramid fiber composite material for the new energy vehicle according to claim 1, wherein the modified aramid fiber material is modified aramid paper, the modified mica material is modified mica paper, and
weight percentages of the raw materials are as follows: 40-60% of the modified aramid fiber paper, 5-20% of the adhesive and 40-60% of the modified mica paper.

9. The corona-resistant mica/aramid fiber composite material for the new energy vehicle according to claim 3, wherein the modified aramid fiber material is modified aramid paper, the modified mica material is modified mica paper, and weight percentages of the raw materials are as follows: 40-60% of the modified aramid fiber paper, 5-20% of the adhesive and 40-60% of the modified mica paper, and
the method for preparing the modified mica material further comprises: S14, adding water and stirring evenly to form a pulp, and performing sheet formation through a paper-forming machine to obtain the modified mica paper.

10. The corona-resistant mica/aramid fiber composite material for the new energy vehicle according to claim 6, wherein the modified aramid fiber material is modified aramid paper, the modified mica material is modified mica paper, and weight percentages of the raw materials are as follows: 40-60% of the modified aramid fiber paper, 5-20% of the adhesive and 40-60% of the modified mica paper, and
the method for preparing the modified aramid fiber material further comprises: S23, performing sheet formation through a paper-forming machine to obtain the modified aramid fiber paper.

11. A method for preparing the corona-resistant mica/aramid fiber composite material for the new energy vehicle according to claim 8, comprising steps of:
S01, unwinding two rolls of the modified aramid fiber paper, and coating the adhesive on surfaces thereof separately;
S02, unwinding the modified mica paper, first attaching the modified mica paper to one modified aramid fiber paper coated with the adhesive, then attaching the other modified aramid fiber paper coated with the adhesive to the other side of the modified mica paper, and oven-drying; and
S03, performing a hot-pressing on a dried composite material through a hot roller, to finally obtain the corona-resistant mica/aramid fiber composite material for the new energy vehicle.

12. The corona-resistant mica/aramid fiber composite material for the new energy vehicle according to claim 1, wherein the modified aramid fiber material is a modified aramid fiber, the modified mica material is modified mica powder,
a weight ratio of the modified aramid fiber to the modified mica powder is (0.1-0.5):1, and an amount of the adhesive added is 5-10% of a total weight of the modified aramid fiber and the modified mica powder.

13. A method for preparing the corona-resistant mica/aramid fiber composite material for the new energy vehicle according to claim 12, comprising steps of:
S01, mixing the modified mica powder with water to make a pulp with a mass concentration of 2-10%, and mixing the modified aramid fiber with water to make a pulp with a mass concentration of 0.1-1%;
S02, mixing and stirring the modified mica powder pulp, the modified aramid fiber pulp and the adhesive evenly; and
S03, adding a mixed pulp into a paper-forming machine for sheet formation, after pressing, oven-drying, and then hot-pressing through a hot roller to finally obtain a corona-resistant mica/aramid fiber blended paper for the new energy vehicle.

14. The preparation method according to claim 13, wherein in step S03, an oven-drying temperature is 120 °C, a hot-pressing temperature is 265-310 °C, and a hot-pressing pressure is 20 Mpa.
